(19) United States
(12) Patent Application Publication
(10) Pub. No.: US 2006/0120644 A1
(43) Pub. Date: Jun. 8, 2006

(54) Self-lubricating bearing

(75) Inventor: Paul Smith, Lincoln (GB)

Correspondence Address: IPSOLON LLP, 111 SW COLUMBIA, SUITE 710, PORTLAND, OR, 97201, US

(73) Assignee: Minebea Co., Ltd.

(21) Appl. No.: 11/281,521

(22) Filed: Nov. 17, 2005

(30) Foreign Application Priority Data
Dec. 3, 2004 (GB) 0426633.4

(51) Int. Cl. F16C 33/02

(52) U.S. Cl. 384/276

(57) ABSTRACT

A self-lubricating bearing comprising a self-lubricating liner and a bearing element having a counterface in sliding contact with the liner. The bearing element is of a titanium alloy having a nitride diffusion layer at the counterface, and the counterface has a surface roughness less than 18 nm.

### TECHNICAL FIELD

The present invention relates to a self-lubricating bearing and in particular to a self-lubricating bearing having an improved counterface.

### BACKGROUND

Self-lubricating bearings typically comprise a housing having a liner which is in sliding contact with a counterface. In the case of spherical bearings, the counterface is provided by the outer surface of a ball and the housing is provided with a self-lubricating liner comprising woven or meshed fibres suffused with a resin to hold together a quantity of PTFE or other self-lubricating material.

Conventional materials for the ball include stainless steel and copper alloys, which are selected for their strength, hardness and resistance to corrosion. The materials, however, are relatively heavy and therefore solutions have been sought using more lightweight materials. In this respect, it is possible to replace stainless steel and copper alloys on a strength basis with titanium alloys which are approximately 40% lighter. Unfortunately, titanium alloys are generally softer than stainless steel and copper alloys. As a result, the counterface of the ball is more susceptible to scoring from debris which find its way between the counterface and liner. Additionally, the surface finish or roughness of the counterface after machining the ball is generally much poorer than that possible with stainless steel and copper alloys. Any irregularities in the counterface wear at and eventually damage the self-lubricating liner. It is therefore important that the counterface has a relatively smooth finish.

U.S. Pat. No. 5,137,374 describes a self-lubricating bearing comprising an inner race having a bearing surface, a self-lubricating liner secured to the bearing surface, and an outer race having a counterface in sliding contact with the liner. The outer race comprises a body of a titanium alloy having a hard coating of titanium nitride or chromium oxide disposed over the counterface. Whilst the hard coating serves to minimise subsequent scoring of the counterface, the surface roughness of the coating substantially corresponds to the underlying surface roughness of the titanium alloy. Consequently, the surface roughness of the counterface remains relatively poor.

### SUMMARY OF THE INVENTION

It is therefore an object of the present invention to provide a self-lubricating bearing comprising a relatively light-weight bearing element having a counterface of improved surface roughness.

In a first aspect, the present invention provides a method of manufacturing a self-lubricating bearing comprising the steps of: providing a bearing element of a titanium alloy; hardening at least a portion of a surface of the bearing element to form a hardened layer; machining a surface of the hardened layer to produce a counterface having a surface roughness of less than 18 nm; providing a self-lubricating liner; and arranging the bearing element and liner such that the counterface is in sliding contact with the liner.

Preferably, the surface of the hardened layer is machined so as to produce a counterface having a surface roughness less than 6 nm.

Advantageously, the step of hardening comprises nitriding at least a portion of a surface of the bearing element and the hardened layer comprises a nitride diffusion layer.

Conveniently, the surface of the bearing element prior to hardening has an initial surface roughness and the hardened layer prior to machining extends to a depth greater than the depth of the initial surface roughness.

Preferably, the hardened layer prior to machining extends to a depth of at least 25 μm.

Advantageously, the hardened layer is machined by electrolytic grinding.

Conveniently, the temperature of the bearing element during hardening is maintained below 750° C.

Preferably, hardening continues for no more than four hours.

Advantageously, the method further comprises the step of coating a surface of the hardened layer after machining to produce the counterface.

Conveniently, the step of coating comprises depositing a layer of material over the surface of the hardened layer.

Preferably, the coating is no more than 4 μm thick.

Advantageously, the hardness of the coating is greater than that of the surface of the hardened layer after machining.

In a second aspect, the present invention provides a self-lubricating bearing comprising a self-lubricating liner and a bearing element having a counterface in sliding contact with the liner, wherein the bearing element is of a titanium alloy having a nitride diffusion layer at the counterface, and the counterface has a surface roughness less than 18 nm.

Preferably, the surface roughness of the counterface is less than 6 nm.

Conveniently, the bearing element further comprises a layer of a wear-resistant material disposed over the nitride diffusion layer.

Advantageously, the hardness of the wear-resistant material is greater than that at the surface of the nitride diffusion layer.

Preferably, the layer of wear-resistant material is no more than 4 μm thick.

Conveniently, the hardness of the counterface is at least 75 Rc.

Advantageously, the counterface has a spherical curvature.

Preferably, the bearing element is a ball.

In a third aspect, the present invention provides a bearing element for use in a self-lubricating bearing, the bearing element being of a titanium alloy and having a nitride diffusion layer at a counterface, and the counterface has a surface roughness less than 18 nm.

In a fourth aspect, the present invention provides a self-lubricating spherical bearing comprising a housing having a spherical bearing surface, a self-lubricating liner secured to the bearing surface, and a ball held within the housing and having a counterface in sliding contact with the liner, wherein the ball is of a titanium alloy having a nitride diffusion layer at the counterface, and the counterface has a surface roughness less than 18 nm.

### BRIEF DESCRIPTION OF THE DRAWINGS

In order that the present invention may be more readily understood, embodiments of the invention will now be described, by way of example, with reference to the accompanying drawings, in which:

FIG. 1 is a cross-sectional view of a self-lubricating bearing embodying the present invention;

FIG. 2 is a exploded cross-sectional view of a region of the self-lubricating bearing of FIG. 1; and

FIG. 3 is an exploded cross-sectional view of a region of an alternative self-lubricating bearing embodying the present invention.

### DETAILED DESCRIPTION

The self-lubricating bearing 1 of FIG. 1 comprises a housing 2 having a bearing surface 3, a self-lubricating liner 4 secured to the bearing surface 3, and a bearing element 5 held within the housing 2 and having a counterface 6 in close sliding contact with the liner 4.

In the embodiment illustrated in FIG. 1, the self-lubricating bearing 1 is a spherical bearing in which the bearing surface 3 and counterface 6 are spherical. Whilst reference will continue to be made to a spherical self-lubricating bearing 1, it is to be understood that the present invention is not limited to spherical bearings but is equally applicable to other forms of self-lubricating bearing, including, but not limited to, cylindrical journal bearings and flat-contact bearings.

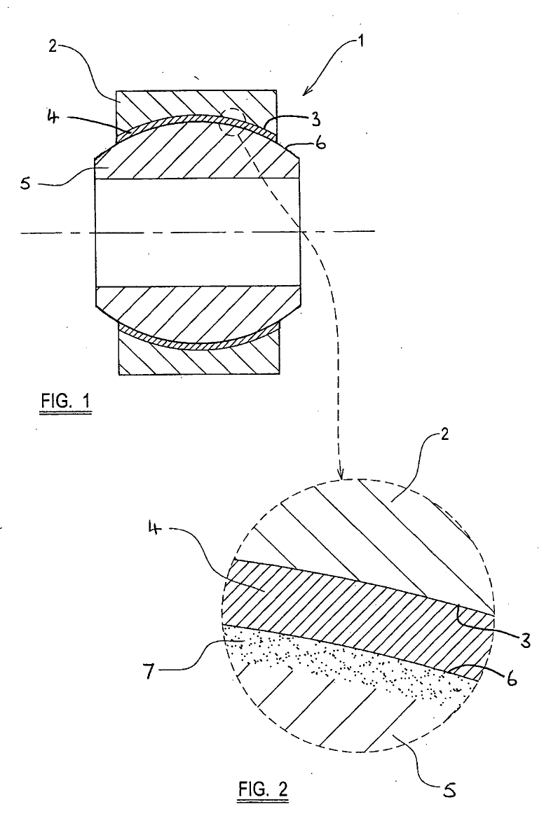

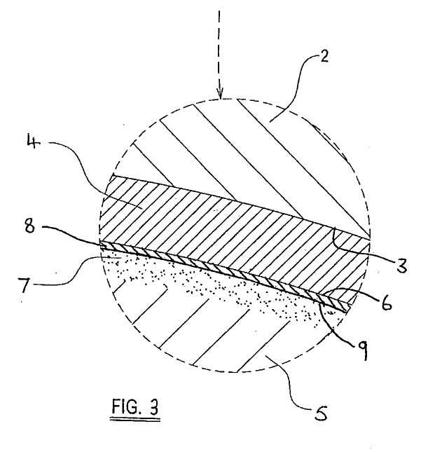

Referring now to FIG. 2, the bearing element 5 is of a titanium alloy having a nitride diffusion layer 7 at the counterface 6. The counterface 6 has a surface roughness of less than 18 nm centreline average (CLA), and preferably less than 6 nm. In having a surface roughness less than 18 mm, potential wear and damage of the self-lubricating liner 4 by the counterface 6 is significantly reduced. As a consequence, the lifespan of the bearing 1 is increased.

The hardness of the counterface 6 is preferably greater than 75 Rc, so as to minimise scoring of the counterface 6 during subsequent use of the self-lubricating bearing 1.

FIG. 3 illustrates an alternative embodiment of the present invention in which the bearing element 5 includes a layer of wear-resistant material 8 disposed over the nitride diffusion layer 7. The layer of wear-resistant material 8 serves to provide a counterface 6 of increased hardness. As a result, scoring of the counterface 6 during subsequent use is further minimised. The hardness of the wear-resistant material 8 is greater than that of the surface 9 of the nitride diffusion layer 7, and is preferably greater than 80 Rc. Suitable wear-resistant materials include, but are not limited to, titanium carbide, titanium nitride, titanium carbonitride, titanium aluminium nitride, chromium nitride, chromium carbide and tungsten carbide, and tungsten carbide-graphite. The thickness of the layer of wear-resistant material 8 is preferably between 1 and 4 μm, and more preferably around 2 μm.

Owing to the thickness and manner in which the layer of wear-resistant material 8 is formed over the surface 9 of the nitride diffusion layer 7, the surface roughness of the counterface 6 is comparable to the underlying surface 9 of the nitride diffusion layer 7. Consequently, a counterface 6 having a surface roughness less than 18 nm, and preferably less than 6 nm, is effectively maintained.

A method of manufacturing the self-lubricating bearing 1 of FIGS. 1 to 3 will now be described.

A bearing element 5 of a titanium alloy is first provided, the outer surface of which provides a counterface 6. Owing to the relative softness of the titanium alloy (which is typically between 30-40 Rc), the counterface 6 at this stage typically has a surface roughness of around 50 nm CLA.

The counterface 6 of the bearing element 5 is then nitrided to form a nitride diffusion layer 7 at the counterface 6. Nitriding is preferably performed by means of a plasma nitriding process employing a triode configuration. The specific details of triodic plasma nitriding have been described elsewhere, e.g. Formation of Aluminum Nitride by Intensified Plasma Ion Nitriding, E. I. Meletis and S. Yan, J. Vac. Sci. Technol., A9, 2279 (1991).

Whilst reference will now be made to the typical conditions employed in nitriding the bearing element 5 by triode plasma nitriding, other forms of nitriding, such as diode plasma nitriding and gas nitriding, may equally be employed. However, triode plasma nitriding is favoured owing to its ability to form relatively thick nitride diffusion layers at relatively low temperatures over relatively short time scales. As a result, the reduction in fatigue strength of the bearing element 5 following the nitriding process is much less than that when diode plasma or gas nitriding is employed. Additionally, manufacturing times are substantially reduced.

Nitriding begins by inserting the bearing element 5 into a nitriding chamber, which is then evacuated and flushed with an inert gas (e.g. argon) several times to remove any oxygen from the chamber. The counterface 6 of the bearing element 5 is then cleaned using conventional sputtering techniques, e.g. holding the bearing element 5 at 2 kV and sputter cleaning with argon for ten or so minutes.

Nitrogen is introduced into the chamber and the pressure within the nitriding chamber is maintained between 1×10⁻³ and 1×10⁻¹ mbar, and preferably around a 1×10⁻² mbar, during the nitriding process. A biasing voltage of between 500 V and 5 kV, and preferably about 1 kV, is then applied to the bearing element 5.

A current is applied to a thermionic emission source (e.g. tungsten filament) such that a current density of between 0.2 and 4 mA/cm², and preferably between about 0.5 and 2 mA/cm², is produced at the bearing element 5. The ion collector is preferably held at between 0 and 150 V and more preferably around 100 V.

At the preferred current density range of 0.5 to 2 mA/cm², the temperature of the bearing element typically rises to between 650 and 700° C., but does not exceed 750° C.

The nitriding process continues until a nitride diffusion layer 7 of preferably at least 10 μm, and more preferably at least 25 μm, thick is formed at the counterface 6. The depth of the nitride diffusion layer 7 depends upon the initial surface roughness of the counterface 6 as well as the desired, final surface roughness. Preferably, the nitride diffusion layer 7 is at least as deep as the features responsible for the initial surface roughness of the counterface 6. Accordingly, the final surface roughness of the counterface 6 is determined only by the machining process (described below), i.e. the initial surface roughness of the counterface 6 does not influence the final surface roughness. More preferably, the nitride diffusion layer 7 is at least 5 μm deeper than the depth of the initial surface roughness of the counterface 6 such that a nitride diffusion layer 7 of at least 5 μm is maintained at the counterface 6 after machining the nitride diffusion layer 7.

In order to obtain a nitride diffusion layer of between 10-25 μm thick, the nitriding process typically lasts between 1 and 3 hours at the preferred conditions outlined above. The processing time naturally depends upon the depth of the nitride diffusion layer 7 as well as the nitriding conditions that are employed, particularly the biasing voltage, the cathode current density, the ion collector voltage, the nitrogen pressure, and the processing time. Longer processing times and/or higher current densities may naturally be employed to achieve a deeper nitride diffusion layer 3. However, the fatigue strength of the bearing element 5 deteriorates with increasing current density (i.e. temperature of the element 5) and processing time. Accordingly, the temperature of bearing element 5 preferably does not exceed 750° C. and the processing time is preferably no greater than 4 hours.

Once the nitride diffusion layer 7 has been formed, the bearing element 5 is removed from the nitriding chamber and the surface of the nitride diffusion layer 7 (i.e. the counterface 6 of the bearing element 5) is machined to achieve a surface roughness of less than 18 nm CLA, and preferably less than 6 nm CLA. Machining of the surface is preferably by electrolytic grinding as described in, for example, EP-A-1078714.

After machining, a nitride diffusion layer 7 of at least 5 μm is preferably maintained at the counterface 6. The nitride diffusion layer 7 is harder than the titanium alloy and therefore provides a harder counterface 6. Additionally, the nitride diffusion layer 7 provides a better surface for adhering a layer of wear-resistant material 8 formed over the bearing element 5. In particular, the layer of wear-resistant material 8 better adheres to the nitride diffusion layer 7 than to a titanium alloy surface.

In manufacturing the self-lubricating bearing 1 of FIG. 3, a layer of a wear-resistant material 8 is deposited over the machined surface 9 of the nitride diffusion layer 7. Conventional methods of deposition, such as electroplating, physical and chemical vapour deposition, may be employed depending upon the material to be deposited. The layer of wear-resistant material 5 is preferably deposited to a thickness of between 1 and 4 μm, and more preferably around 2 μm. The surface roughness of the layer of wear-resistant material 8 corresponds substantially to that of the underlying machined surface 9 of the nitride diffusion layer 7.

As a consequence of machining the nitride diffusion layer 7 prior to depositing the layer of wear-resistant material 8 result, no machining of the wear-resistant material 8 is required in order to obtain a counterface 6 surface roughness less than 18 nm. This offers a significant benefit over alternative methods of forming the self-lubricating bearing 1 of FIG. 3, in which a thick (˜30 μm) layer of wear-resistant material 8 is deposited over the bearing element 5 (with or without the nitride diffusion layer 7) and then subsequently machined. Owing to the relative softness of the underlying titanium alloy, machining the layer of wear-resistant material 8 can cause the layer 8 to crack and/or separate from the bearing element 5.

With the method of the present invention, relatively lightweight bearing elements having relatively smooth counterfaces may be manufactured for use in self-lubricating bearings. In particular, titanium alloy bearing elements may be manufactured with a surface roughness at the counterface of less than 18 nm CLA.

Owing to the relative softness of titanium alloys, there is a difficulty in machining the alloy to obtain the desired surface finish. The present invention overcomes this problem by providing a hardened layer (e.g. nitride diffusion layer) which may be more easily machined. Consequently, smoother surface finishes are made feasible and hence the lifespan of the self-lubricating bearing is increased.

Additionally, bearing elements having a hard coating disposed over the counterface may be manufactured, again with a final surface roughness of less than 18 nm CLA, without the need to machine the coating. Consequently, the problems normally associated with machining a thin, hard coating deposited on a metal body (e.g. cracking, spalling and/or separation of the coating from the metal body) are no longer an issue.

When used in this Specification and Claims, the terms “comprises” and “comprising” and variations thereof mean that the specified features, steps or integers are included. The terms are not to be interpreted to exclude the presence of other features, steps or components.

The features disclosed in the foregoing description, or the following Claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of manufacturing a self-lubricating bearing comprising the steps of:
providing a bearing element of a titanium alloy;
hardening at least a portion of a surface of the bearing element to form a hardened layer;
machining a surface of the hardened layer to produce a counterface having a surface roughness of less than 18 nm;
providing a self-lubricating liner; and
arranging the bearing element and liner such that the counterface is in sliding contact with the liner.

2. A method as claimed in claim 1, wherein the surface of the hardened layer is machined so as to produce a counterface having a surface roughness less than 6 nm.

3. A method as claimed in claim 1, wherein the step of hardening comprises nitriding at least a portion of a surface of the bearing element and the hardened layer comprises a nitride diffusion layer.

4. A method as claimed in claim 1, wherein the surface of the bearing element prior to hardening has an initial surface roughness and the hardened layer prior to machining extends to a depth greater than the depth of the initial surface roughness.

5. A method as claimed in claim 1, wherein the hardened layer prior to machining extends to a depth of at least 25 μm.

6. A method as claimed in claim 1, wherein the hardened layer is machined by electrolytic grinding.

7. A method as claimed in claim 1, wherein the temperature of the bearing element during hardening is maintained below 750° C.

8. A method as claimed in claim 1, wherein hardening continues for no more than four hours.

9. A method as claimed in claim 1, wherein the method further comprises the step of coating a surface of the hardened layer after machining to produce the counterface.

10. A method as claimed in claim 9, wherein the step of coating comprises depositing a layer of material over the surface of the hardened layer.

11. A method as claimed in claim 9, wherein the coating is no more than 4 μm thick.

12. A method as claimed in claim 9, wherein the hardness of the coating is greater than that of the surface of the hardened layer after machining.

13. A self-lubricating bearing comprising a self-lubricating liner and a bearing element having a counterface in sliding contact with the liner, wherein the bearing element is of a titanium alloy having a nitride diffusion layer at the counterface, and the counterface has a surface roughness less than 18 nm.

14. A bearing as claimed in claim 13, wherein the surface roughness of the counterface is less than 6 nm.

15. A bearing as claimed in claim 13, wherein the bearing element further comprises a layer of a wear-resistant material disposed over the nitride diffusion layer.

16. A bearing as claimed in claim 15, wherein the hardness of the wear-resistant material is greater than that at the surface of the nitride diffusion layer.

17. A bearing as claimed in claim 15, wherein the layer of wear-resistant material is no more than 4 μm thick.

18. A bearing as claimed in claim 13, wherein the hardness of the counterface is at least 75 Rc.

19. A bearing as claimed in claim 13, wherein the counterface has a spherical curvature.

20. A bearing as claimed in claim 13, wherein the bearing element is a ball.

21. A bearing element for use in a self-lubricating bearing, the bearing element being of a titanium alloy and having a nitride diffusion layer at a counterface, and the counterface has a surface roughness less than 18 nm.

22. A self-lubricating spherical bearing comprising a housing having a spherical bearing surface, a self-lubricating liner secured to the bearing surface, and a ball held within the housing and having a counterface in sliding contact with the liner, wherein the ball is of a titanium alloy having a nitride diffusion layer at the counterface, and the counterface has a surface roughness less than 18 nm.
